(19) United States
(12) Patent Application Publication
(10) Pub. No.: US 2023/0204549 A1
(43) Pub. Date: Jun. 29, 2023

(54) APPARATUS AND AUTOMATED METHOD FOR EVALUATING SENSOR MEASURED VALUES, AND USE OF THE APPARATUS

(71) Applicant: SIEMENS AKTIENGESELLSCHAFT, München (DE)

(72) Inventors: Alexander Michael Gigler, Untermeitingen (DE); Susanne Kornely, Puchheim (DE); Andreas Hangauer, München (DE)

(21) Appl. No.: 17/915,792

(22) PCT Filed: Mar. 23, 2021
(86) PCT No.: PCT/EP2021/057446

§ 371 Date: Sep. 29, 2022

(30) Foreign Application Priority Data
Mar. 31, 2020 (DE) 10 2020 204 140.7

(51) Int. Cl. G01N 30/86

(52) U.S. Cl. CPC G01N 30/8675; G01N 2030/025

(57) ABSTRACT

The invention specifies an apparatus for evaluating sensor measured values (1.1), having: —a sensor (1), wherein a model function that is suitable for a least squares regression and definable by a parameter vector is provided for evaluating the sensor measured values (1.1) of the sensor (1), wherein at least one parameter of the parameter vector forms a sensor output signal (3), and —a computing and evaluation unit (2) that has a neural network (2.1), which estimates the parameter vector on the basis of actually ascertained sensor measured values (1.1), and a least squares regression module (2.2), wherein the neural network (2.1) is trained with parameter vectors and the associated sensor measured values, and that is set up: ^{∘}—to use the trained neural network (2.1) to ascertain at least one parameter estimate vector for sensor measured values (1.1) measured using the sensor (1) as an input variable for the least squares regression module (2.2), ^{∘}—if a convergence criterion is satisfied for the performance of the least squares regression, to terminate the least squares regression and ^{∘}—to output the at least one parameter of the most recently ascertained parameter vector as sensor output signal (3). An associated automated method for evaluating sensor measured values and a use of the apparatus are likewise specified.

### CROSS REFERENCE TO RELATED APPLICATIONS

This present patent document is a § 371 nationalization of PCT Application Serial Number PCT/EP2021/057446, filed Mar. 23, 2021, designating the United States, which is hereby incorporated in its entirety by reference. This patent document also claims the benefit of DE 10 2020 204 140.7, filed on Mar. 31, 2020, which is also hereby incorporated in its entirety by reference.

### FIELD

Embodiments relate to a device and to an automated, for example computer-implemented, method for evaluating sensor measured values, for example in spectroscopy.

### BACKGROUND

Sensor data are often evaluated by way of signal processing in a digital computer. Signal processing is often necessary since the sensor hardware, that is often analog, does not directly deliver the desired quantity or information that is required. The signal processing may involve a simple linear temperature correction or spectral analysis up to complex image or video analysis.

One known systematic data evaluation method is that of model-based data evaluation. In this case, a computing model, also called model function, is present for the behavior of the sensor hardware, including the relevant physical environment on the basis of the parameters of interest. This is used to evaluate the (digital) data (=measured data) delivered by the sensor hardware by way of a least squares regression. The resulting parameter estimates, that is to say the parameters that deliver the best reproduction (in the least squares sense) in terms of the measured values, form or deliver the sensor output values (=sensor output signal).

A non-linear regression is carried out in the general case and a linear regression is carried out in the special case when the model is linear with regard to all parameters. In mathematical terms, this corresponds to a model inversion that is typically carried out using suitable, known iterative methods. The advantage of least squares regression is that it is asymptotically efficient under general requirements. This means that this method for determining the parameters is optimum in the statistical sense. There is no method that is true to expectation and that is able to deliver a small error in the parameter estimation. The model-based data evaluation approach with a non-linear regression is therefore a systematic approach that is expediently able to be used wherever a sufficiently exact model of the sensor hardware or physical system is present or is able to be created relatively easily.

The least squares method (or just least squares) is the standard mathematical method for equalization calculus. In this case, a function is determined for a set of data points, this function running as close as possible to the data points and thus combining the data as best possible. The most commonly used function is the line, that is then called best fit line. In order to be able to apply the method, the function has to contain at least one parameter. These parameters are then determined by the method such that, if the function is compared with the data points and the distance between function value and data point is squared, the sum of these squared distances becomes as low as possible. The sum of the squared distances is called residual sum of squares. The vector of the distances between function value and data point is called residual. The residual sum of squares is thus the square of the (Euclidean) vector absolute value of the residual.

These methods are typically used to examine real data, for example physical data. These data often contain unavoidable measurement errors and fluctuations. Assuming that the measured values are close to the underlying “true values” and there is a specific relationship between the measured values, the method may be used to find a function that describes this relationship between the data as accurately as possible. The method may also be applied in reverse form in order to test various functions and thereby to describe an unknown relationship in the data.

One problem however lies in the calculation of the model inversion. Use is typically made of iterative methods (Levenberg-Marquardt or the like) that require relatively good initial parameter estimates in order to determine the global optimum, that is to say the best possible fit between model and measurement vector.

Up until now, the starting values have been determined using heuristic methods in least squares regression methods. These may be methods that are derived from the specific model using expert knowledge, or else general heuristic methods, such as for example Nelder Mead. In the case of complicated problems, these methods however also fail.

Another approach to sensor data evaluation is that of considering AI-based (AI=artificial intelligence) data evaluation. Artificial neural networks or the like are used here in order to perform the data evaluation by way of machine learning (for example using reinforcement learning). One major problem here is that of ensuring trustworthiness. For instance, it is generally not possible to reliably predict how the AI will behave when it receives measured data that lie outside its field of training. Incorrect analysis or certifications for safety-critical tasks therefore cannot be performed easily.

Nevertheless, there are problems that are able to be solved only by way of AI and for which no other signal processing methods are available, such as for example in the case of tasks from the field of image-based object recognition.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide improved evaluation of sensor measured values.

Embodiments combine evaluation of sensor measured values with artificial intelligence of a neural network and a least squares (LS) regression. A sufficiently accurate computing model (=model function) is present for the sensor data evaluation, that is to say one as is required, for example, for the least squares regression. The computing model may be used to simulate an arbitrarily large number of scenarios that correspond to a realistic measurement situation. The model function is described by parameters that form a parameter vector. Random parameter vectors are then generated from the parameter space, and the model function is evaluated. These parameter vectors form the ground truth.

Together with the result vectors of the model function, a neural network is then trained, the neural network being intended to predict the parameter vectors. This is the conventional reinforcement learning approach for AI-based data evaluation. In the specific measurement task, the initial parameter estimated vector is then first determined for each actually measured measurement vector (including measured values) using the AI. This initial parameter estimated vector serves as initial value for the following least squares regression. If this converges and the residual meets a predefined criterion, for example norm smaller than a predefined limit, the data evaluation is marked as “successful”. The parameter estimates (or a selection thereof) of the LS regression form the one or more sensor output signals. If the data evaluation is unsuccessful, then a fault message (=“unsuccessful”) is output.

A “neural network” denotes any apparatus suitable for machine learning.

Embodiments provide a device for evaluating sensor measured values, including a sensor. A model function suitable for a least squares regression and able to be defined by a parameter vector is provided for an evaluation of the sensor measured values of the sensor. At least one parameter of the parameter vector forms a sensor output signal. The device further includes a computing and evaluation unit that includes a neural network that estimates the parameter vector on the basis of actually ascertained sensor measured values and a least squares regression module. The neural network is trained with parameter vectors and the associated sensor measured values, and that is configured: to ascertain at least one parameter estimated vector as input quantity for a least squares regression of the least squares regression module for sensor measured values measured by the sensor by way of the trained neural network, to terminate the least squares regression when a convergence criterion is met when carrying out the least squares regression, and to output the at least one parameter of the last ascertained parameter vector from the least squares regression with the smallest square error as sensor output signal.

A sensor, also called a detector or measurement sensor, is a technical component that is able to detect physical or chemical properties (such as for example amount of heat, temperature, moisture, pressure, acoustic field quantities, brightness, acceleration, pH value, ion strength or electrochemical potential) and/or the material property of its environment in terms of quality or in terms of quantity as a measured quantity. These quantities are acquired by way of physical or chemical effects and converted into an electrical signal that is able to be evaluated.

In one development, the computing and evaluation unit may have an assessment module, connected downstream of the least squares regression module, that is configured to ascertain a success status of the evaluation from the residual of the least squares regression, information about the termination status of the least squares regression and at least one further item of information about the least squares regression and to output it as further sensor output signal. The success status may be “successful” or “unsuccessful”. The success status is a binary quantity.

In a further embodiment, the assessment module may be configured, in order to ascertain the success status, to additionally take the at least one parameter of the last ascertained parameter vector and/or the sensor measured values into consideration.

In a further refinement, the assessment module may be configured to ascertain quality information about the evaluation from the residual of the least squares regression, information about the termination status of the least squares regression and at least one further item of information about the least squares regression and to output it as further sensor output signal.

The quality information, also called “quality of sensing”, is a continuous, non-negative scalar variable.

The quality information may be the Euclidean norm of the residual or the dimensionless-normalized Euclidean norm of the residual.

In a further embodiment, the assessment module is configured to set the success status to “successful” when the quality information remains below a predefined quality threshold.

In a further refinement, the assessment module may be configured, from signals from multiple least squares regressions, to select one thereof, for example, out of those with the success status “successful”, one of these having the smallest square error.

Embodiments further provide for the use of the device for the evaluation of a chromatogram in gas chromatography.

Embodiments further provide for the use of the device for spectral evaluation in spectroscopy.

Embodiments further provide for the use of the device for the spectral evaluation of timeseries.

The use is for example the use for the evaluation of measured voltage/current, ultrasonic vibrations or the like, to test the state or establish the state of technical devices or apparatuses.

Embodiments further provide for the use of the device for the analysis of audio data, such as for example speech.

Embodiments further provide for the use of the device for the recognition of objects in image data, for example in automated component recognition in production.

Embodiments provide an automated method for evaluating sensor measured values. A model function suitable for a least squares regression and able to be defined by a parameter vector is provided for an evaluation of the sensor measured value. A sensor output signal is formed by at least one parameter of the parameter vector. A neural network that estimates the parameter vector on the basis of actually ascertained sensor measured values and a least squares regression module is provided. The neural network is trained with parameter vectors and the associated sensor measured values. At least one parameter estimated vector is ascertained as input quantity for a least squares regression of the least squares regression module for measured sensor values by way of the trained neural network, the least squares regression is terminated when a convergence criterion is met when carrying out the least squares regression and the at least one parameter of the last ascertained parameter vector from the least squares regression with the smallest square error is output as sensor output signal.

A success status of the evaluation may be ascertained from the residual of the least squares regression, information about the termination status of the least squares regression and at least one further item of information about the least squares regression and output as further sensor output signal. The success status may be “successful” or “unsuccessful.”

To ascertain the success status, the at least one parameter of the last ascertained parameter vector and/or the sensor measured values may additionally be taken into consideration.

In a further embodiment, quality information about the evaluation may be ascertained from information about the termination status of the least squares regression and at least one further item of information about the least squares regression and output as further sensor output signal.

The combination of artificial intelligence of a neural network as initial estimator and an LS regression as “refinement” with a concluding test includes the following advantages. If the regression is “successful”, there is a good degree of certainty that the data evaluation delivers correct parameter values. These are thus identical to the values that are true in physical terms, apart from noise. In comparison with a pure LS regression: The method is more robust, since it does not require any separate starting value estimation. In comparison with the pure LS regression: The method is faster, since the LS fit requires only a few additional iterations. In comparison with a pure AI: The method is verified, that is to say the result parameters are checked with a (verified) model as to whether they match the measurement vector. In comparison with a pure AI: The method delivers more accurate results. The AI alone often does not achieve very high accuracy of the parameter estimates, in contrast to the LS regression, that is an asymptotically efficient estimator.

Further features and advantages of the will become apparent from the following explanations of embodiments with reference to schematic drawings.

### BRIEF DESCRIPTION OF THE DRAWINGS

FIG. 1 depicts a block diagram of a device for evaluating sensor measured values according to an embodiment.

FIG. 2 depicts a flowchart of a method for evaluating sensor measured values according to an embodiment.

### DETAILED DESCRIPTION

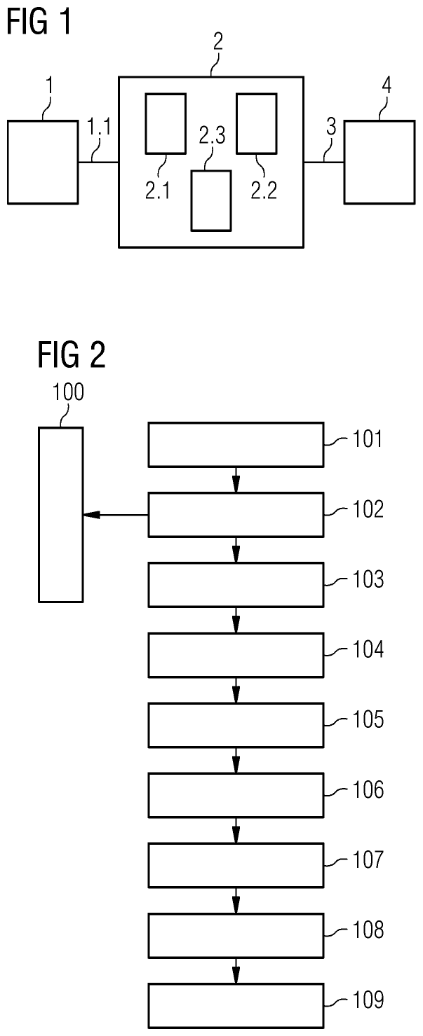

FIG. 1 depicts a block diagram of a device for evaluating sensor measured values 1.1. A sensor 1 generates sensor measured values 1.1, that serve as input signal for a computing and evaluation unit 2. To evaluate the sensor measured values 1.1 of the sensor 1, provision is made for a model function suitable for a least squares regression, which model function is able to be defined by a parameter vector. At least one parameter of the parameter vector forms a sensor output signal 3. The sensor output signal 3 and further sensor output signals are output and displayed on a display unit 4.

The computing and evaluation unit 2, for example a computer, includes a neural network 2.1 that estimates the parameter vector on the basis of actually ascertained sensor measured values 1.1 and a least squares regression module 2.2. The neural network 2.1 has been trained with parameter vectors and the associated sensor measured values 1.1. The computing and evaluation unit 2 is configured to ascertain at least one parameter estimated vector as input quantity for the least squares regression module 2.2 for sensor values 1.1 measured by the sensor 1 by way of the trained neural network 2.1. The least squares regression is terminated when a convergence criterion is met when carrying out the least squares regression and the one or more parameters of the last ascertained parameter vector are output as sensor output signal 3.

The convergence criterion may for example be falling below a predefined threshold value of the residual sum of squares of the least squares regression, a predefinable maximum number of iterations or a predefinable maximum time.

The computing and evaluation unit 2 also includes an assessment module 2.3 that is connected downstream of the least squares regression module 2.2. Inputs for the assessment module 2.3 are for example the residual of the last model evaluation of the least squares regressions in the least squares regression module, information about the termination status of the least squares regressions and at least one further item of information about the least squares regressions. From the inputs, the assessment module 2.3 ascertains a success status of the evaluation and outputs this as further sensor output signal 3. The success status may be “successful” or “unsuccessful”. When ascertaining the success status, in addition, at least one parameter of the last ascertained parameter vector of the least squares regressions and/or the sensor measured values 1.1 may additionally be taken into consideration.

The assessment module 2.3 may also be configured to ascertain quality information about the evaluation from the residual of the least squares regressions, information about the termination status of the least squares regression and at least one further item of information about the least squares regressions and to output it as further sensor output signal 3. The quality information (also able to be called “quality of sensing”) is a continuous, non-negative scalar variable. The quality information may be for example the Euclidean norm of the residual or the dimensionless-normalized Euclidean norm of the residual of the selected least squares regression.

The assessment module may also be configured to set the success status to “successful” when the quality information remains below a predefined quality threshold.

One variant of the abovementioned ascertainment of the quality information is that of restricting the area of the formation of the Euclidean norm. If for example it is known that the relevant information is located in a certain area in the measurement vector, then this may be selected in a targeted manner and the deviation between model and measurement may be examined only in this area. The area containing the relevant information may be output from the last model evaluation as “auxiliary quantity”.

One further variant is that of applying weight factors (->vector) to the residual prior to forming the Euclidean norm. A “soft” selection thus takes place, in contrast to the “hard” masking (previous case). The weight factors are likewise output with the last evaluation of the model function as auxiliary quantities.

A further variant makes provision to link the least squares regression algorithm to the termination status, for example using a heuristic policy that additionally assesses certain termination status events negatively.

The described device may be used, inter alia, for an evaluation of a chromatogram in gas chromatography. Good initial parameter starting values for the least squares regression are very important here, since, due to the large number of peaks, there are a large number of local minima in the LS regression task and only one of these is the correct global optimum, e.g., the convergence of a typical LS regression, for example its algorithm, is not robust. The described device may be used for a spectral evaluation in high-resolution spectroscopy, for example spectroscopy based on tunable lasers. In this case too, good initial parameter starting values for the LS regression are very important, since, due to the spectral fingerprint, there are a large number of local minima and only one of these is the correct global optimum, e.g., the convergence of a typical LS regression algorithm is not robust. The described device may be used for a spectral evaluation of timeseries, such as for example of measured voltage/current, ultrasonic vibrations or the like, to check the state or establish the state of technical devices or apparatuses. Resonances (that is to say peaks) are often contained in spectral data of timeseries of physical signals. These often follow specific patterns, such as individual peaks may contain harmonics. Since there may be multiple base resonances, the resulting spectrum may appear highly complex. If a generic model is to be adapted, then the base resonance frequencies first have to be known. Identifying these is a challenging problem that is exacerbated by noise that is present and any other interfering signals. If it is necessary to adapt a model in which the parameters that influence the base resonant frequencies are adapted, an initial estimate thereof is essential for a successful LS regression. One example is the state monitoring of the current of a motor of unknown size and speed. The described device may be used for an analysis of audio data, such as speech. The AI of the neural network here may perform speech recognition and determine further parameters for speech synthesis. The physical model here is a suitable speech synthesis module. It should be able to be parameterized, such that the speech spoken by the speaker is able to be reproduced sufficiently accurately by way of the further parameters. The verification step is performed by comparing the measurement with the synthesis signal. The described device may be used for an identification of objects in image data. Good models (CAD or the like) of the objects of interest are often present in industrial applications. The scenery may be simulated with a suitable variation of (interfering) backgrounds. Parameters such as position of the object or of the objects are parameters of the computing model, along with orientation in space. The AI of the neural network is trained to estimate at least these parameters. The LS regression is then used to improve the estimate, and the verification is then performed. An LS regression that operates on image data is no different in principle from a (one-dimensional) non-linear regression. The model is compared point for point with the measurement (the recorded image) and then the mean squared error is formed.

In the case of image data analysis, other test criteria may be used that are more expedient, for example weighting of the model and measurement before the squared deviation is calculated. A weight function may then for example weight the areas more where the payload signal includes a high amplitude, or where the desired “information” is contained. This may be used to suppress interference outside the area of interest and thus to reduce the rejection rate.

FIG. 2 depicts a flowchart of an automated, for example computer-implemented, method for evaluating sensor measured values. In the first step 101, a model function suitable for an LS regression and able to be defined by a parameter vector is provided for an evaluation of the sensor measured values. A sensor output signal is formed by at least one parameter of the parameter vector. In the second step 102, a neural network that estimates the parameter vector on the basis of actually ascertained sensor measured values and a least squares regression module are provided. The neural network has been trained with parameter vectors and the associated sensor measured values in a previous step 100.

In the third step 103, at least one parameter estimated vector is ascertained as input quantity for the least squares regression module for measured sensor values by way of the trained neural network. In the following fourth step 104, the LS regression is carried out and the least squares regression is terminated when a convergence criterion is met when carrying out the least squares regression. In a fifth step 105, the at least one parameter of the last ascertained parameter vector is then output as sensor output signal.

In a sixth step 106, a success status of the evaluation is ascertained from the residual of the least squares regression, information about the termination status of the least squares regression and at least one further item of information about the least squares regression and, in the seventh step 107, is output as further sensor output signal. The success status may be “successful” or “unsuccessful”.

In order to ascertain the success status in the sixth step 106, at least one parameter of the last ascertained parameter vector and/or the sensor measured values may additionally be taken into consideration.

In the eighth step 108, quality information about the evaluation is ascertained from information about the termination status of the least squares regression and at least one further item of information about the least squares regression and, in the ninth step 109, is output as further sensor output signal.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A device for evaluating sensor measured values the device comprising:
a sensor configured to provide sensor measured values, wherein a model function suitable for a least squares regression and configured to be defined by a parameter vector is provided for an evaluation of the sensor measured values of the sensor, wherein at least one parameter of the parameter vector forms a sensor output signal; and
an evaluation unit including a neural network that is configured to estimate the parameter vector based on actually ascertained sensor measured values and a least squares regression module, wherein the neural network is trained with parameter vectors and associated sensor measured values, the neural network further configured to ascertain at least one parameter estimated vector as input quantity for a least squares regression of the least squares regression module for sensor measured values measured by the sensor by way of the trained neural network, to terminate the least squares regression when a convergence criterion is met when carrying out the least squares regression, and to output the at least one parameter of a last ascertained parameter vector from the least squares regression with the smallest square error as sensor output signal;
wherein the evaluation unit includes an assessment module connected downstream of the least squares regression module, the assessment module configured to ascertain a success status of the evaluation from a residual of the least squares regression, information about a termination status of the least squares regression, and at least one further item of information about the least squares regression, the assessment module configured to output the success status, the information, and the at least one further item of information as a further sensor output signal, wherein the success status may be successful or unsuccessful.

2. (canceled)

3. The device of claim 1, wherein the assessment module is configured to ascertain the success status based further on the at least one parameter of the last ascertained parameter vector, the sensor measured values, or the at least on parameter of the last ascertained parameter vector and the sensor measured values.

4. The device of claim 1, wherein the assessment module is configured to ascertain quality information about the evaluation from the residual of the least squares regression, information about the termination status of the least squares regression and at least one further item of information about the least squares regression and to output the quality information, the information about the termination status, and the at least one further item as the further sensor output signal.

5. The device of claim 4, wherein the quality information is a Euclidean norm of the residual or a dimensionless-normalized Euclidean norm of the residual.

6. The device of claim 4, wherein the assessment module is configured to set the success status to “successful” when the quality information remains below a predefined quality threshold.

7. The device of claim 1, wherein the sensor is configured to provide sensor measured values for an evaluation of a chromatogram in gas chromatography.

8. The device of claim 1, wherein the sensor is configured to provide sensor measured values for spectral evaluation in spectroscopy.

9. The device of claim 1, wherein the sensor is configured to provide sensor measured values for a spectral evaluation of timeseries.

10. The device of claim 1, wherein the sensor is configured to provide sensor measured values for an analysis of audio data.

11. The device of claim 1, wherein the sensor is configured to provide sensor measured values for a recognition of objects in image data.

12. An automated method for evaluating sensor measured values, the method comprising:
providing a model function configured for a least squares regression and configured to be defined by a parameter vector for an evaluation of the sensor measured values, wherein a sensor output signal is formed by at least one parameter of the parameter vector;
providing a neural network configured to estimate the parameter vector based on actually ascertained sensor measured values and a least squares regression module, wherein the neural network is trained with parameter vectors and associated sensor measured values;
ascertaining at least one parameter estimated vector as input quantity for a least squares regression of the least squares regression module for measured sensor values by the trained neural network, wherein the least squares regression is terminated when a convergence criterion is met when carrying out the least squares regression and the at least one parameter of the last ascertained parameter vector from the least squares regression with the smallest square error is output as sensor output signal; and
ascertaining and outputting a success status of the evaluation from a residual of the least squares regression, information about a termination status of the least squares regression, and at least one further item of information about the least squares regression, wherein the success status may be successful or unsuccessful.

13. (canceled)

14. The method of claim 12, wherein, the at least one parameter of the last ascertained parameter vector, the sensor measured values, or the last ascertained parameter vector and the sensor measured values are used to ascertain the success status.

15. The method of claim 12, wherein quality information about the evaluation is ascertained from information about the termination status of the least squares regression and at least one further item of information about the least squares regression and output as a further sensor output signal.
